(19) United States
(12) Patent Application Publication
(10) Pub. No.: US 2023/0045120 A1
(43) Pub. Date: Feb. 9, 2023

(54) DIRECT TO CONSUMER COLLECTIBLE SYSTEM AND METHOD

(71) Applicant: The Upper Deck Company, Carlsbad, CA (US)

(72) Inventors: Jason Masherah, San Marcos, CA (US); Benjamin Swiderski, San Marcos, CA (US)

(21) Appl. No.: 17/880,459

(22) Filed: Aug. 3, 2022

Related U.S. Application Data
(60) Provisional application No. 63/229,350, filed on Aug. 4, 2021.

(51) Int. Cl. G06Q 40/04

(52) U.S. Cl. CPC G06Q 40/04

(57) ABSTRACT

A direct-to-consumer collectible system (100) for use by a consumer of a collectible array including an NFT collectible, a digital collectible, and a physical collectible. The collectible system can include a centralized collectible system (102), an NFT collectible system (104), and a physical collectible system (106). The centralized collectible system (102) allows the consumer to one of buy, trade, and store the collectible array. The NFT collectible system (104) allows the consumer to purchase NFT collectibles. The NFT collectible system (104) can be configured so that NFT collectibles are transferable between the NFT collectible system (104) and the centralized collectible system (102). The physical collectible system (106) allows the consumer to purchase physical collectibles. The physical collectible system (106) can be configured so that physical collectibles can be transferred between the physical collectible system (106) and the centralized collectible system (102).

### RELATED APPLICATION

This application claims priority on U.S. Provisional Application Ser. No. 63/229,350, filed on Aug. 4, 2021, and entitled “DIRECT TO CONSUMER COLLECTIBLE SYSTEM AND METHOD.” To the extent permitted, the contents of U.S. Provisional Application Ser. No. 63/229,350 are incorporated in their entirety herein by reference.

### BACKGROUND

Modernly, consumers of collectibles have many options available to them on the online marketplace. For example, a consumer can purchase collectibles at an online store and have these collectibles shipped to their home or other location. Unfortunately, existing online marketplace options are not entirely satisfactory. Consumers often are required to purchase a collectible in one online location and initiate a slow transfer of the collectible to a new online location. Intermingling one or more online collectible marketplaces can be challenging where digital collectibles are attached to a public blockchain ledger in one online location and collectibles are bound to private ledgers in another online location. Other problems can include the difficulty in building a fully integrated system that (i) intermingles digital, physical, and hybrid collectible items, (ii) allows instantaneous transactions and/or trades of the collectible items, and (iii) tracks and identifies the status of each collectible item. Many conventional collectible systems can only accommodate one type of collectible item (physical, digital, or hybrid), and these systems cannot intermingle the varying types of collectible items.

### SUMMARY

The present invention is directed toward a direct-to-consumer collectible system for use by a consumer of a collectible array including a non-fungible token (“NFT”) collectible, a digital collectible, and a physical collectible. In various embodiments, the collectible system includes a centralized collectible system, an NFT collectible system, and a physical collectible system. The centralized collectible system allows the consumer to one of buy, trade, and store the collectible array. The NFT collectible system allows the consumer to purchase NFT collectibles. The NFT collectible system can be configured so that NFT collectibles are transferable between the NFT collectible system and the centralized collectible system. The physical collectible system allows the consumer to purchase physical collectibles, the physical collectible system can be configured so that physical collectibles can be transferred between the physical collectible system and the centralized collectible system.

In some embodiments, the NFT collectible is tradeable for the physical collectible in the centralized collectible system.

In certain embodiments, the centralized collectible system, the NFT collectible system, and the physical collectible system cooperate to facilitate the buying, storing, selling, shipping, and transferring of collectibles by the consumer.

In various embodiments, collectibles are freely transferable within the direct-to-consumer collectible system.

In some embodiments, the direct-to-consumer collectible system is configured to allow the consumer to play games including the NFT collectible, the digital collectible, and the physical collectible.

In certain embodiments, the direct-to-consumer collectible system is configured to allow the consumer to trade collectibles with other consumers.

In various embodiments, the collectible centralized location is configured to offer digital packs, physical packs, hybrid packs, containers, and boxes for sale to the consumer, the digital packs, physical packs, hybrid packs, containers, and boxes, including NFT collectibles, digital collectibles, and physical collectibles.

In some embodiments, the direct-to-consumer collectible system is implemented on at least a processor and a database.

In certain embodiments, the direct-to-consumer collectible system assigns status identifiers to each of the plurality of collectibles within the collectible system.

In various embodiments, the direct-to-consumer collectible system is configured to determine and display an ownership status of a corresponding collectible within the collectible system.

In some embodiments, the direct-to-consumer collectible system identifies and displays the location of each collectible within the direct-to-consumer collectible system.

In certain embodiments, the direct-to-consumer collectible system identifies and displays an ability of each collectible to be one of shipped and combined with other collectibles.

In some embodiments, the direct-to-consumer collectible system is configured to update ownership information of a corresponding collectible after the corresponding collectible is one of acquired, traded, sold, shipped, combined with other collectibles, and redeemed for an achievement.

In various embodiments, the direct-to-consumer collectible system is configured to update a functionality of each collectible as it moves through subsystems of the direct-to-consumer collectible system.

The present invention is also directed toward a method for operation of a direct-to-consumer collectible system for use by a consumer. In some embodiments, the method comprises the steps of transacting collectibles in a centralized collectible system, transferring an NFT collectible from an NFT collectible system to the centralized collectible system, and transferring a physical collectible from a physical collectible system to the centralized collectible system.

In some embodiments, the method can further include the step of trading the NFT collectible for the physical collectible in the centralized collectible system.

In certain embodiments, the method can further include the step of trading the NFT collectible for a second NFT collectible in the centralized collectible system.

In various embodiments, the method can further include the step of trading the physical collectible for a second physical collectible in the centralized collectible system.

In some embodiments, the method can further include the step of displaying an ability of each collectible to be one of shipped and combined with other collectibles.

The present invention is also directed toward a method for transacting and transferring a collectible within a direct-to-consumer collectible system for use by a consumer. In certain embodiments, the method comprises the steps of: implementing a series of pathways between a centralized collectible system, an NFT collectible system, a physical collectible system, and a collectible consignment system; creating a new set of status identifiers that identify a status of each of the collectibles within the direct-to-consumer collectible system; creating an intermingled collection of all collectible types for use in games, and receiving achievements, rewards, badges, and accolades; and creating functionality for each of the collectibles to have transfer and ownership protocols within each subsystem of the collectible system.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic illustration of an embodiment of a direct-to-consumer collectible system having features of the present invention

FIG. 2 is a simplified schematic illustration of yet another embodiment of a direct-to-consumer collectible system; and

FIG. 3 is a flowchart illustrating an embodiment of the operation of the direct-to-consumer collectible system illustrated in FIG. 1.

While embodiments of the present invention are susceptible to various modifications and alternative forms, specifics thereof, have been shown by way of example and drawings, and are described in detail herein. It is understood, however, that the scope herein is not limited to the particular embodiments described. On the contrary, the intention is to cover modifications, equivalents, and alternatives falling within the spirit and scope herein.

### DESCRIPTION

Embodiments of the present invention are described herein in the context of a robust direct-to-consumer collectible system and method. The direct-to-consumer collectible system provides a unique system to buy, sell, transfer, assign, and exchange items that may be digital-only, for physical and/or digital goods. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention, as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and/or business-related constraints, and that these specific goals will vary from one implementation to another and from one developer to another. Moreover, it will be appreciated that such a development effort might be complex and time-consuming. However, it would nevertheless be a routine undertaking of engineering for those of ordinary skill in the art having the benefit of this disclosure.

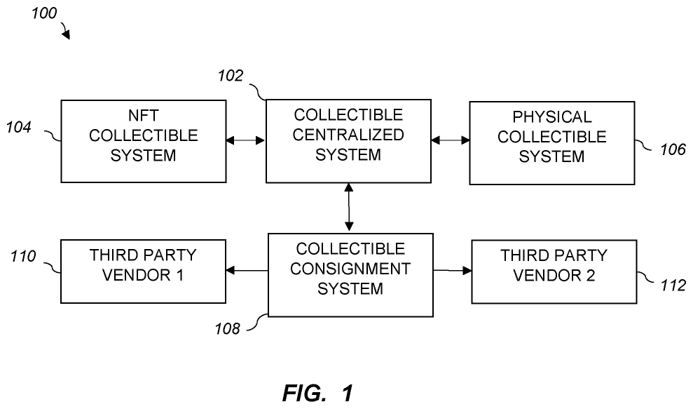

FIG. 1 is a simplified schematic illustration of an embodiment of a direct-to-consumer collectible system 100 (also referred to herein simply as a “collectible system”) having features of the present invention. The design of the collectible system 100 can be varied. In certain embodiments, as illustrated in FIG. 1, the collectible system 100 can include a collectible centralized system 102, a non-fungible token (“NFT”) collectible marketplace 104, a physical collectible system 106, a collectible consignment system 108, a first third-party vendor 110, and a second third-party vendor 112. Alternatively, the collection system 100 can include more components, elements, systems, and/or subsystems or fewer components, elements, systems, and/or subsystems than those specifically illustrated and described in FIG. 1.

As used herein, “collectibles” can be understood to mean, without limitation, one or more of the following: physical collectibles (such as trading cards, memorabilia, artwork, game-used items, professional sports collectibles, other non-professional sports collectibles, entertainment collectibles, venue surfaces included in any portion of a sporting venue, an entertainment venue, a historical venue or any other suitable type of venue, flooring, walls, ceiling, court, seats, benches, fields and/or surfaces of any professional or non-professional sporting venue, with such sports including, without limitation, basketball, baseball, football, hockey, soccer, tennis, etc.), digital collectibles (such as electronic trading cards, digital artwork, video clips, songs, sound clips), NFT collectibles, hybrid collectibles (such as a physical trading card with a corresponding electronic trading card counterpart, an NFT with a physical counterpart), and/or any suitable physical, digital, or hybrid item that may be collected. Additionally, as referred to herein, the term “non-professional” may include semi-professional, collegiate, and/or amateur sports individuals or teams, or entertainers or celebrities, or public figures.

As used herein, “digital collectible” means, without limitation, all digital collectible types, excluding NFT collectibles.

The collectible centralized system 102, the NFT collectible system 104, and the physical collectible system 106 can cooperate to provide for the buying, storing, selling, shipping, and transferring of any type of digital and/or physical collectibles by consumers. It should be appreciated that the various functions/operations (e.g., buying, storing, selling, shipping, transferring, packaging, etc.) and roles of any of the systems and subsystems provided for herein, can be combined, shared, and/or divided up in any suitable manner as needed to complete the functions/operations.

Stated in another manner, any of the functions, operations, or roles that are described herein as to be accomplished by any of the collectible centralized system 102, the NFT collectible system 104, and the physical collectible system 106 can be performed by any of the other of the collectible centralized system 102, the NFT collectible system 104, and the physical collectible system 106. Additionally, any such functions or roles can be combined in any suitable manner, such that the general function of transferring collectibles between the systems and/or between consumers can be accomplished by any one of the collectible centralized system 102, the NFT collectible system 104, and the physical collectible system 106.

As an overview, in certain embodiments, the collectible system 100 is configured to provide a unique system for the transfer and use of any type of collectible, including physical, digital, and hybrid (both physical and digital). In various embodiments, the collectible system 100 allows users to buy collectibles, store their collectibles in a collection, and play various games with their collectibles, trade and/or their collectibles with any other user around the world, all within the collectible system 100. A series of pathways between the subsystems of the collectible system 100 can be created to allow the instantaneous exchange and/or transfer between subsystems. The collectible system 100 can also assign a unique set of identifiers to tell the user the status (digital, NFT, physical, and hybrid) of each collectible.

The collectible system 100 can incorporate one or more levels of stock-keeping units (“SKUs”) that are assigned to each collectible within the collectible system 100. The SKUs can each be unique identifiers assigned to each collectible for purposes of ownership tracking and inventory tracking. The SKUs can be recorded on a private ledger and/or a public ledger (such as a blockchain).

The collectible centralized system 102 is a system (or subsystem) to facilitate collecting by allowing the system operator and/or controller to distribute, sell and trade collectibles of all types. As described in detail herein, the direct-to-consumer collectible system and method provide benefits such as ease for the user of providing a single, integrated system where the user can store, transact, and transfer their collectibles. In some embodiments, the collectible centralized location 102 can offer a number of digital packs, physical packs, hybrid packs, containers, and/or boxes for sale to a consumer that can include any type of collectible, including physical, digital, and hybrid collectibles. Within the collectible centralized system 102, any type of collectible can be traded and/or exchanged for any type of collectible (e.g., physical for digital, digital for digital, NFT for NFT, digital for NFT, etc.).

The collectible centralized system 102 can vary depending on the design requirements of the collectible system 100. It is understood that the collectible centralized system 102 can include additional components, systems, subsystems, and elements other than those specifically shown and/or described herein. Additionally, or alternatively, the collectible centralized system 102 can omit one or more of the components, systems, subsystems, and elements that are specifically shown and/or described herein.

The NFT collectible system 104 is a system (or subsystem) for collecting, distributing, buying, selling, trading, NFT collectibles. In some embodiments, the NFT collectibles can be freely transferred between the collectible centralized system 102 and the NFT collectible system 104. In certain embodiments, the NFT collectibles can only be transferred from the NFT collectible system 104 to the collectible centralized system 102. In various embodiments, the NFT collectible system 104 is the only subsystem of the collectible system 100 that can sell NFT collectibles to users of the collectible system 100. In some embodiments, NFT collectibles with physical components can be transferred from the NFT collectible system 104 to the collectible centralized system 102

The NFT collectible system 104 can vary depending on the design requirements of the collectible system 100. It is understood that the NFT collectible system 104 can include additional components, systems, subsystems, and elements other than those specifically shown and/or described herein. Additionally, or alternatively, the NFT collectible system 104 can omit one or more of the components, systems, subsystems, and elements that are specifically shown and/or described herein.

The physical collectible system 106 is a system (or subsystem) to facilitate collecting by allowing the system operator to distribute and sell physical collectibles. In some embodiments, physical collectibles can be freely transferred from the physical collectible system 106 to the collectible centralized system 102. In certain embodiments, physical collectibles can be freely transferred between the physical collectible system 106 and the collectible centralized system 102

The physical collectible system 106 can vary depending on the design requirements of the collectible system 100. It is understood that the physical collectible system 106 can include additional components, systems, subsystems, and elements other than those specifically shown and/or described herein. Additionally, or alternatively, the physical collectible system 106 can omit one or more of the components, systems, subsystems, and elements that are specifically shown and/or described herein.

The collectible consignment system 108 is a system (or subsystem) for collecting, distributing, buying, selling, trading, physical collectibles. In particular, the collectible consignment system 108 can facilitate the sale of physical collectibles on any number of third-party vendors, including the first third-party vendor 110 and the second third-party vendor 112. The consignment marketplace 108 can simultaneously list collectibles on the first third-party vendor 110 and the second third-party vendor 112.

The collectible consignment system 108 can vary depending on the design requirements of the collectible system 100, the first third-party vendor 110, and/or the second third-party vendor 112. It is understood that the collectible consignment system 108 can include additional components, systems, subsystems, and elements other than those specifically shown and/or described herein. Additionally, or alternatively, the collectible consignment system 108 can omit one or more of the components, systems, subsystems, and elements that are specifically shown and/or described herein.

The collectible system 100 can be implemented on any number of suitable devices and/or components, including network systems and communications networks. The devices can be, or their functionality can include, integrated circuits, processors, controllers, microprocessors, databases, storage devices, diodes, capacitors, power storage elements, antennae, ASICs, sensors, image elements (e.g., CMOS, CCD imaging elements), amplifiers, ND, and D/A converters, associated differential amplifiers, buffers, microprocessors, optical collectors, transducer including electro-mechanical transducers, piezoelectric actuators, light-emitting electronics which include LEDs, logic, memory, clock, and transistors including active matrix switching transistors, and combinations thereof. The purpose and advantage of using standard ICs (in embodiments, CMOS, on single crystal silicon) are to have and use high quality, high performance, and high functioning circuit components that are also already commonly mass-produced with well-known processes, and which provide a range of functionality and generation of data far superior to that produced by a passive means.

Components within electronic devices or devices are described herein and include those components described herein. A component can be one or more of any of the electronic devices described herein and/or may include a photodiode, LED, TUFT, electrode, semiconductor, other light-collecting/detecting components, transistor, contact pad capable of contacting a device component, thin-film devices, circuit elements, control elements, microprocessors, interconnects, contact pads, capacitors, resistors, inductors, a memory element, power storage element, antenna, logic element, buffer and/or other passive or active components. A device component may be connected to one or more contact pads as known in the art, such as metal evaporation, wire bonding, application of solids or conductive pastes, and the like.

The devices and/or components of the collectible system 100 can: (1) assign status identifiers to the various collectibles within the collectible system 100, (2) determine and display the ownership status of an individual collectible item within the collectible system 100, (3) identify the marketplace, location, or subsystem within the collectible system 100 where a collectible currently resides, (4) identify the ability of a collectible to be shipped and/or combined with other collectibles, (5) update the ownership information for each collectible after the collectible is initially acquired, traded, sold, shipped, combined with other collectibles, or redeemed for an achievement, and (6) update the functionality of a collectible as the collectible is transferred to the marketplace, location, or subsystem within the collectible system 100 where a collectible currently resides.

Additionally, the devices and/or components of the collectible system 100 can: (1) can assign and update various states of the collectible items within the collectible system 100, including whether it is physical, digital, or hybrid, item ownership, which site the item is residing on, whether the item can be shipped, can be combined, etc., (2) updating the status of each collectible item so the ownership of each item can be tracked after it is initially acquired, and subsequently traded, sold, shipped, combined, or redeemed for an achievement, (3) Updating the tracking information to track which website they currently reside on, which has implications for certain item features that are unique to each site in the ecosystem.

As described in detail herein, the direct-to-consumer collectible system 100 and method for transferring and completing operations with collectibles provide benefits such as ease for the user for purchasing collectibles in only one location, commingling and storing digital, physical, and hybrid collectibles in one collection, allow the user to play games with their digital, physical, and hybrid collectibles on the collectible system 100, and facilitate the trading of collectibles on the collectible system 100. As a result, users of the collectible system 100 can freely move their owned collectibles between the collectible centralized system 102, a non-fungible token (“NFT”) collectible marketplace 104, a physical collectible system 106, a collectible consignment system 108, a first third party vendor 110, and a second third party vendor 112. The collectibles can move between the subsystems of the collectible system 100 at a much faster speed than convention systems, resulting in an increased volume of transactions between consumers involving a greater variety of digital and/or physical collectibles.

The direct-to-consumer collectible system 100 and method for transferring and completing operations with collectibles described herein can also provide benefits to the system host, such as enabling rapid adjustment to collectible containers, digital packaging, product content and design, game collectible integration, and development, product pricing based on consumer feedback, purchasing activity, and other market trends. The different types of collectible items (e.g., physical, hybrid, NFT, digital, etc.) can be combined for gamification like achievements, games. The collectible system 100 can be programmed to provide this functionality.

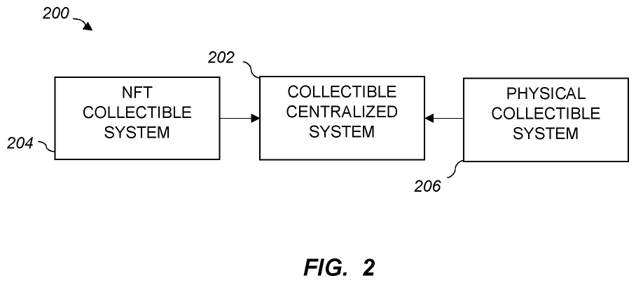

FIG. 2 is a simplified schematic illustration of an embodiment of a direct-to-consumer collectible system 200 (also referred to herein simply as a “collectible system”) having features of the present invention. The direct-to-consumer collectible system 200 embodiment displayed in FIG. 2 can be somewhat similar to the direct-to-consumer collectible system 100 embodiment illustrated in FIG. 1. The design of the collectible system 200 can be varied. In certain embodiments, as illustrated in FIG. 2, the collectible system 200 can include a collectible centralized system 202, an NFT collectible system 204, and/or a physical collectible system 206. Alternatively, the collection system 200 can include more components, elements, systems, and/or subsystems or fewer components, elements, systems, and/or subsystems than those specifically illustrated and described in FIG. 2.

As an overview, in certain embodiments, the collectible system 200 is configured to provide a unique system for the transfer and use of any type of collectible, including physical, digital, and hybrid (both physical and digital). In various embodiments, the collectible system 200 allows users to buy collectibles, store their collectibles in a collection, and play various games with their collectibles, trade and/or their collectibles with any other user around the world, all within the collectible system 200. A series of pathways between the subsystems of the collectible system 200 can be created to allow the instantaneous exchange and/or transfer between subsystems. The collectible system 200 can also assign a unique set of identifiers to tell the user the status (digital, physical, and hybrid) of each collectible.

In the embodiment displayed in FIG. 2, NFT collectibles on the NFT collectible system 204 can only be transferred from the NFT collectible system 204 to the collectible centralized system 202 (and not the other way around, such as displayed in the embodiment displayed in FIG. 2). Similarly, in the embodiment displayed in FIG. 2, physical collectibles on the physical collectible system 206 can only be transferred from the physical collectible system 206 to the collectible centralized system 202 (and not the other way around, such as displayed in the embodiment displayed in FIG. 2).

The collectible system 200 can incorporate one or more levels of stock-keeping units (“SKUs”) that are assigned to each collectible within the collectible system 200. The SKUs can each be unique identifiers assigned to each collectible for purposes of ownership tracking and inventory tracking. The SKUs can be recorded on a private ledger and/or a public ledger (such as a blockchain).

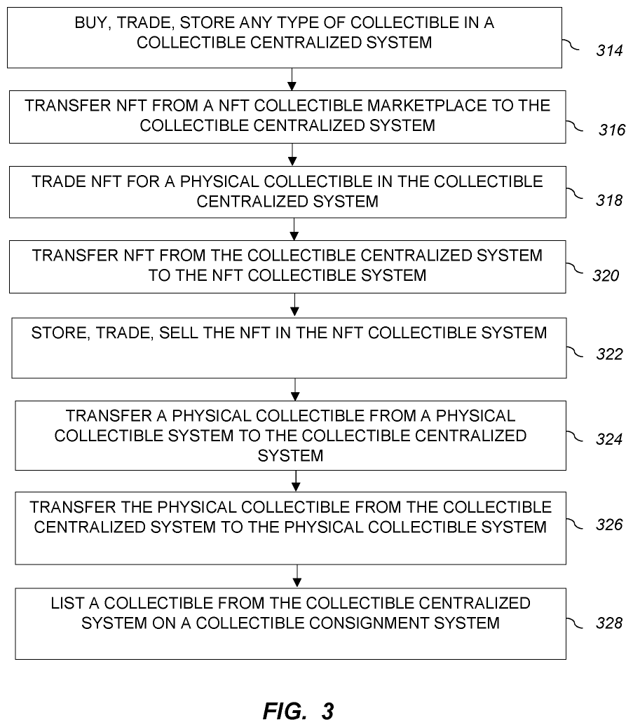

FIG. 3 is a flowchart illustrating an embodiment of the operation of the direct-to-consumer collectible system 100 illustrated in FIG. 1. More specifically, FIG. 3 more explicitly illustrates an embodiment of the general operations and functionality of the collectible system 100 illustrated in FIG. 1. It should be appreciated that the various steps described herein can be modified as necessary in the process of operating the collectible system 100. Processors within the collectible system 100 can assign collectible items to statistical categories for the collectible items. Additionally, it should also be appreciated that the order of the steps can be modified, certain steps can be omitted, and/or additional steps can be added without limiting the intended scope and breadth of the present invention.

At step 314, the user can buy, trade, and/or store any type of physical, digital, and/or hybrid collectible in the collectible centralized system 102. The collectible centralized system 102 is a system (or subsystem) for collecting, distributing, buying, selling, trading, collectibles of all types. As described in detail herein, the direct-to-consumer collectible system and method provide benefits such as ease for the user of providing a single, integrated system where the user can store, transact, and transfer their collectibles. In some embodiments, the collectible centralized location 102 can offer a number of digital packs, containers, and/or boxes for sale to a consumer that can include any type of collectible, including physical, digital, and hybrid collectibles.

At step 316, the user can transfer an NFT collectible from the NFT collectible system 104 to the collectible centralized system 102. The NFT collectible system 104 is a system (or subsystem) for collecting, distributing, buying, selling, trading, NFT collectibles. NFT collectibles can be freely transferred between the collectible centralized system 102 and the NFT collectible system 104.

At step 318, the user can trade an NFT collectible for a physical collectible in the collectible centralized system 102. The physical collectible system 106 is a system (or subsystem) for collecting, distributing, buying, selling, trading, physical collectibles. Physical collectibles can be freely transferred between the collectible centralized system 102 and the physical collectible system 106.

At step 320, the user can transfer an NFT collectible from the collectible centralized system 102 to the NFT collectible system 104.

At step 322, the user can store, trade, and/or sell the NFT collectible in the NFT collectible system 104.

At step 324, the user can transfer a physical collectible from the physical collectible system 106 to the collectible centralized system 102. During checkout, the user has the option (if available) to either ship the physical collectible item home or transfer it to their collection on the collectible centralized system 102. In some embodiments, only one option (ship or transfer) will be available and selected by default. Once the transaction is complete, if the user chooses to have the item transferred, it will be transferred to the collectible centralized system 102 immediately after purchase and show up in their collection on collectible centralized system 102. Because all the subsystems within the collectible system 100 use a single sign-on, when they complete the purchase on the physical collectible system 106, there will be an option on the order completion page where they can be taken to view the newly purchased items (within their collection) on the collectible centralized system 102. If the user chooses to have the physical collectible item shipped, the shipping request will be sent to the applicable warehouse(s), where the item(s) will be picked, packed, and shipped to the consumer.

At step 326, the user can transfer a physical collectible from the collectible centralized system 102 to the physical collectible system 106.

At step 328, the user can list a collectible from the collectible centralized system 102 on the collectible consignment system 108. The collectible consignment system 108 is a system (or subsystem) for collecting, distributing, buying, selling, trading, physical collectibles. In particular, the collectible consignment system 108 can facilitate the sale of physical collectibles on any number of third-party vendors, including the first third-party vendor 110 and the second third-party vendor 112. The consignment marketplace 108 can simultaneously list collectibles on the first third-party vendor 110 and the second third party vendor 112.

It should be understood that the collectible system 100 described herein can solve a number of technical issues that arise when physical, digital, and hybrid collectibles are combined in one environment. For example, the intermingling and cooperation of multiple online marketplaces with collectibles that are both on a public blockchain ledger and private ledger can disrupt ownership tracking and cause issues for the system provider. Similarly, trading and transacting the physical, digital, and hybrid collectibles can cause issues for users when transacting collectibles of different types and ownership tracking.

The direct-to-consumer collectible system 100 allows for the combination and transacting of the physical, digital, and hybrid collectibles all within the integrated collectible system 100. The collectible system 100 remedies the technical issues described herein with a number of technical solutions: (1) the collectible system 100 implements a series of pathways between the collectible centralized system 102, the non-fungible token (“NFT”) collectible marketplace 104, the physical collectible system 106, the collectible consignment system 108, the first third party vendor 110, and the second third party vendor 112 that facilitate the exchange and/or transfer of data and/or collectibles between the various subsystems, (2) the collectible system 100 creates a new set of status identifiers that identify the status of the collectibles (e.g., whether they are physical, digital, hybrid, or NFT collectibles; item states of the collectibles that indicate their current functionality within the collectible system 100 that allows for certain actions to be executed, such as transferability between various subsystems), (3) the collectible system 100 creates a intermingled collection with all collectible types for use in games and for receiving achievements, rewards, badges, accolades, (4) the collectible system 100 creates functionality for specific collectible types (e.g., physical vs. digital) that allows the specific type of collectible to have specific transfer and ownership protocols within the subsystems of the collectible system 100.

The direct-to-consumer collectible system 100 enables: (1) the purchase of collectible digital items, physical items, and hybrid digital/physical items, (2) the storing of said collectible items in one collection, (3) the trading and/or transacting of said collectible items with other collectors worldwide, (4) the shipping of physical items directly to consumers, and (5) the integration of unique identifiers and ownership tracking information that is verified and ledgered on both public and private ledgers. Integrating various subsystems within the collectible system 100 increases the speed of transactions within the collectible system 100 (in some embodiments, the instantaneous transfer between subsystems).

Additionally, the direct-to-consumer collectible system 100 can help bring in a new generation of collectors, who can be taught how to collect through rewards such as achievements that encourage collecting, digital, physical, and hybrid products with low purchase prices, interactive games involving the collectibles, etc. For example, lower price points for digital products can decrease barriers to entry into the hobby and allow younger audiences to experience the enjoyment of collecting.

It is understood that although a number of different embodiments of the collectible system 100 have been illustrated and described herein, one or more features of any one embodiment can be combined with one or more features of one or more of the other embodiments, provided that such combination satisfies the intent of the present invention.

While a number of exemplary aspects and embodiments of a direct-to-consumer collectible system 100 have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

What is claimed is:

1. A direct-to-consumer collectible system for use by a consumer of a collectible array including an NFT collectible, a digital collectible, and a physical collectible, the collectible system comprising:
a centralized collectible system that allows the consumer to one of buy, trade, and store the collectible array;
an NFT collectible system that allows the consumer to purchase NFT collectibles, the NFT collectible system being configured so that NFT collectibles are transferable between the NFT collectible system and the centralized collectible system; and
a physical collectible system that allows the consumer to purchase physical collectibles, the physical collectible system being configured so that physical collectibles can be transferred between the physical collectible system and the centralized collectible system.

2. The collectible system of claim 1 wherein the NFT collectible is tradeable for the physical collectible in the centralized collectible system.

3. The collectible system of claim 1 wherein the centralized collectible system, the NFT collectible system, and the physical collectible system cooperate to facilitate the buying, storing, selling, shipping, and transferring of collectibles by the consumer.

4. The collectible system of claim 1 wherein collectibles are freely transferable within the direct-to-consumer collectible system.

5. The collectible system of claim 1 wherein the direct-to-consumer collectible system is configured to allow the consumer to play games including the NFT collectible, the digital collectible, and the physical collectible.

6. The collectible system of claim 1 wherein the direct-to-consumer collectible system is configured to allow the consumer to trade collectibles with other consumers.

7. The collectible system of claim 1 wherein the collectible centralized location is configured to offer digital packs, physical packs, hybrid packs, containers, and boxes for sale to the consumer, the digital packs, physical packs, hybrid packs, containers, and boxes including NFT collectibles, digital collectibles, and physical collectibles.

8. The collectible system of claim 1 wherein the direct-to-consumer collectible system is implemented on at least a processor and a database.

9. The collectible system of claim 1 wherein the direct-to-consumer collectible system assigns status identifiers to each of the plurality of collectibles within the collectible system.

10. The collectible system of claim 1 wherein the direct-to-consumer collectible system is configured to determine and display an ownership status of a corresponding collectible within the collectible system.

11. The collectible system of claim 1 wherein the direct-to-consumer collectible system identifies and displays the location of each collectible within the direct-to-consumer collectible system.

12. The collectible system of claim 1 wherein the direct-to-consumer collectible system identifies and displays an ability of each collectible to be one of shipped and combined with other collectibles.

13. The collectible system of claim 1 wherein the direct-to-consumer collectible system is configured to update ownership information of a corresponding collectible after the corresponding collectible is one of acquired, traded, sold, shipped, combined with other collectibles, and redeemed for an achievement.

14. The collectible system of claim 1 wherein the direct-to-consumer collectible system is configured to update a functionality of each collectible as it moves through subsystems of the direct-to-consumer collectible system.

15. A method for operation of a direct-to-consumer collectible system for use by a consumer, the method comprising the steps of:
transacting collectibles in a centralized collectible system;
transferring an NFT collectible from an NFT collectible system to the centralized collectible system; and
transferring a physical collectible from a physical collectible system to the centralized collectible system.

16. The method of claim 15 further comprising the step of trading the NFT collectible for the physical collectible in the centralized collectible system.

17. The method of claim 15 further comprising the step of trading the NFT collectible for a second NFT collectible in the centralized collectible system.

18. The method of claim 15 further comprising the step of trading the physical collectible for a second physical collectible in the centralized collectible system.

19. The method of claim 15 further comprising the step of displaying an ability of each collectible to be one of shipped and combined with other collectibles.

20. A method for transacting and transferring a collectible within a direct-to-consumer collectible system for use by a consumer, the method comprising the steps of:
implementing a series of pathways between a centralized collectible system, an NFT collectible system, a physical collectible system, and a collectible consignment system;
creating a new set of status identifiers that identify a status of each of the collectibles within the direct-to-consumer collectible system;
creating an intermingled collection of all collectible types for use in games and receiving achievements, rewards, badges, and accolades; and
creating functionality for each of the collectibles to have transfer and ownership protocols within each subsystem of the collectible system.
